(19) United States
(12) Patent Application Publication
(10) Pub. No.: US 2020/0160434 A1
(43) Pub. Date: May 21, 2020

(54) SERVER APPARATUS AND INFORMATION PROVISION METHOD

(71) Applicant: TOYOTA JIDOSHA KABUSHIKI KAISHA, Toyota-shi (JP)

(72) Inventors: Ryota OSUMI, Nagoya-shi (JP); Hiroyuki NAKAJIMA, Nagoya-shi (JP); Toshiomi YAMADA, Nagoya-shi (JP); Daijiro MORIWAKI, Nagoya-shi (JP)

(73) Assignee: TOYOTA JIDOSHA KABUSHIKI KAISHA, Toyota-shi (JP)

(21) Appl. No.: 16/668,514

(22) Filed: Oct. 30, 2019

(30) Foreign Application Priority Data
Nov. 16, 2018 (JP) 2018-215941

(51) Int. Cl. G06Q 30/08; G06F 16/903

(52) U.S. Cl. CPC G06Q 30/08; G06F 16/90335

(57) ABSTRACT

A server apparatus includes circuitry configured to acquire identification information of a vehicle exhibited in an auction from an auction company, acquire history information of the exhibited vehicle based on the acquired identification information, derive provision information including a driving tendency of a past driver of the exhibited vehicle based on the acquired history information, and provide the derived provision information to the auction company.

### INCORPORATION BY REFERENCE

The disclosure of Japanese Patent Application No. 2018-215941 filed on Nov. 16, 2018 including the specification, drawings and abstract is incorporated herein by reference in its entirety.

### BACKGROUND

### 1. Technical Field

The present disclosure relates to a server apparatus and an information provision method.

### 2. Description of Related Art

Japanese Unexamined Patent Application Publication No. H04-342065 (JP 4-342065 A) discloses an auction processing apparatus that displays, on an image, a vehicle type, model year, mileage, fouling of the exterior, a damaged portion, and the like, of a vehicle exhibited at a place of auction for used vehicles. A bidder can decide a bid price based on the image.

### SUMMARY

However, with a technology disclosed in JP 4-342065 A, it is impossible to provide information that is difficult to be realized from checking or inspecting the exterior of a vehicle, such as how the exhibited vehicle was driven by the past driver. For this reason, even though the vehicle is in good condition because of the driver's careful driving tendency, auction participants cannot realize the good condition, and therefore accuracy in determining a minimum successful bid price and a bid price may be low.

The present disclosure provides a server apparatus and an information provision method that can assist an auction participant of a vehicle to determine a bid price with improved accuracy.

A first aspect of the disclosure provides a server apparatus including circuitry configured to: acquire identification information of an exhibited vehicle which is exhibited in an auction from an auction company; acquire history information of the exhibited vehicle based on the identification information; derive provision information including a driving tendency of a past driver of the exhibited vehicle based on the history information; and provide the provision information to the auction company.

With the above aspect, since the provision information including the driving tendency of the past driver of the exhibited vehicle can be provided to the auction participant, it is possible for the participant to determine a bid price with improved accuracy for the exhibited vehicle.

In the first aspect, the circuitry may be configured to derive the provision information in a predetermined format according to at least one of the auction company, a destination to which the auction company provides the provision information, a type of the exhibited vehicle, and a model of the exhibited vehicle

In the first aspect, the circuitry may be configured to derive the provision information in a predetermined format.

In the first aspect, the history information may include maintenance information of the exhibited vehicle.

In the first aspect, the server apparatus may further include a memory configured to store history information of a plurality of vehicles. The circuitry may be configured to: prepare statistical information of the history information of the plurality of vehicles based on the history information of the plurality of vehicles; and derive the provision information based on the statistical information.

In the first aspect, the driving tendency may be calculated based on at least one of an evaluated value for eco-driving, an evaluated value for safe driving, and an evaluated value for vehicle-friendly driving, the evaluated value for the eco-driving being calculated based on at least one of a gas mileage of the exhibited vehicle and a length of an overall period during which an eco-mode is selected, the evaluated value for the safe driving being calculated based on the number of times a safety equipment mounted on the exhibited vehicle is activated, the evaluation value for the vehicle-friendly driving being calculated based on information relating to rapidity of acceleration, deceleration and steering of the exhibited vehicle.

In the first aspect, the circuitry may be configured to provide, in response to a request from the auction company, additional information including information that is not included in the provision information to the auction company, after providing the provision information to the auction company.

A second aspect of the present disclosure provides an information provision method including: acquiring identification information of an exhibited vehicle that is exhibited in an auction from an auction company; acquiring history information of the exhibited vehicle based on the identification information; deriving provision information including a driving tendency of a past driver of the exhibited vehicle based on the history information; and providing the provision information to the auction company.

A third aspect of the present disclosure provides an information provision method including: acquiring history information of a plurality of vehicles; deriving provision information including a driving tendency of a past driver of each of the plurality of vehicles based on the history information, and storing the provision information in a memory; acquiring identification information of an exhibited vehicle exhibited in an auction from an auction company, the exhibited vehicle being included in the plurality of vehicles; acquiring the provision information of the exhibited vehicle from the memory, based on the identification information; and providing the provision information of the exhibited vehicle to the auction company.

With each aspect of the present disclosure, it is possible for an auction participant to determine a bid price with improved accuracy for the exhibited vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system according to a first embodiment;

FIG. 2 is a diagram illustrating a flow of data of the information processing system illustrated in FIG. 1;

FIG. 3 is a block diagram illustrating a configuration of a first server apparatus illustrated in FIG. 1;

FIG. 4 is an exemplified display of a vehicle status check sheet of a hybrid-type vehicle, prepared by the first server apparatus 10 of FIG. 1;

FIG. 5 is an exemplified display of a vehicle status check sheet of a gasoline-powered vehicle, prepared by the first server apparatus 10 of FIG. 1;

FIG. 6 is an exemplified display of a vehicle status check sheet of an electric vehicle (EV) or a fuel cell vehicle (FCV), prepared by the first server apparatus 10 of FIG. 1; and

FIG. 7 is a flowchart illustrating a process of the first server apparatus in FIG. 1.

### DETAILED DESCRIPTION OF EMBODIMENTS

### First Embodiment

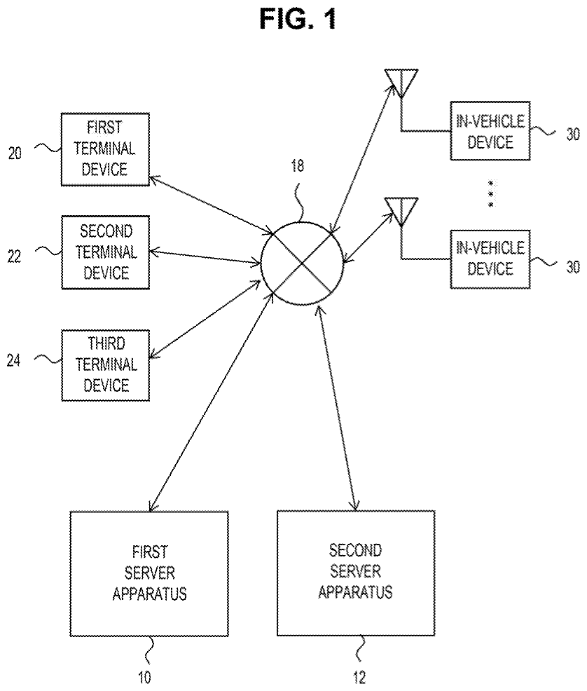

FIG. 1 illustrates a configuration of an information processing system 1 according to a first embodiment. The information processing system 1 is used for supporting in a transaction when a vehicle is traded as a used vehicle, based on history information of the vehicle collected from the vehicle. Specifically, the information processing system 1 is used in vehicle auctions.

The information processing system 1 includes a first server apparatus 10, a second server apparatus 12, a first terminal device 20, a second terminal device 22, a third terminal device 24, and a plurality of in-vehicle devices 30.

The in-vehicle device 30 has a wireless communication function, and is connected to a network 18 via a wireless base station or a wireless access point (not shown). Each of the second server apparatus 12, the first terminal device 20, the second terminal device 22, and the third terminal device 24 is connected to the network 18 via wired or wireless communication. The first server apparatus 10 is connected to the network 18, and can communicate with the second server apparatus 12, the first terminal device 20, the second terminal device 22, the third terminal device 24, and the in-vehicle device 30 via the network 18.

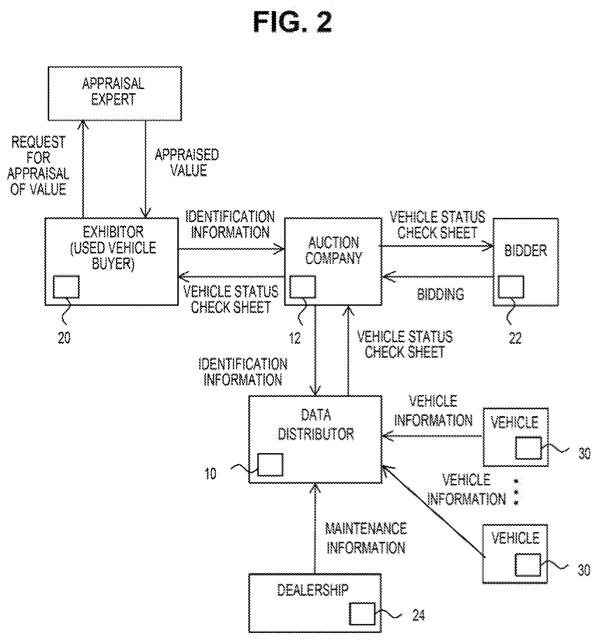

FIG. 2 illustrates a flow of data of the information processing system 1, illustrated in FIG. 1. The first server apparatus 10 is provided in a data center of a data distributor. The data distributor may be a car manufacturer. The second server apparatus 12 is managed by an auction company that holds vehicle auctions.

The first terminal device 20 is used by an auction exhibitor, such as a used vehicle purchaser, a vehicle dealer, a vehicle leasing company, a vehicle rental company, and the like. The auction exhibitor is also a vehicle purchaser since he or she purchases a vehicle from an owner of a vehicle, and exhibits the purchased vehicle at the auction. When the exhibitor purchases the vehicle from the owner, the exhibitor may request an appraisal expert to appraise the value of the vehicle, and acquire the appraised value from the appraisal expert. Examples of the appraisal expert include a vehicle inspection company, a residual value calculation company, and the like.

The second terminal device 22 is used by an auction bidder, such as a used vehicle seller, a vehicle parts company, a vehicle dismantler, a scrapped vehicle buyer, and the like. The third terminal device 24 is provided in facilities that maintain or repair vehicles, such as a dealership or a maintenance factory. The in-vehicle device 30 is mounted on a vehicle, which is an automobile.

Although illustration is omitted, the information processing system 1 may include a plurality of auction companies, appraisal expert, auction exhibitors, bidders and dealers. In addition, a plurality of second server apparatuses 12 and a plurality of first terminal devices 20 to third terminal devices 24 may be provided.

The in-vehicle device 30 periodically acquires vehicle information of a subject vehicle, and periodically transmits the vehicle information to the first server apparatus 10. The vehicle information is attached with a date and time at which the vehicle information is acquired. The vehicle information is also referred to as CAN data, and includes information, such as speed, longitudinal acceleration, lateral acceleration, deceleration, an accelerator operation amount, a brake operation amount, a steering angle, fuel consumption per unit time, an eco-mode selection state, an odometer value, operation information of safety equipment, various sensor values of the engine, and various sensor values related to a drive battery (a lithium ion secondary battery). The eco-mode indicates a fuel consumption-oriented mode in which the engine RPM is kept lower than that in the standard mode while the vehicle is traveling.

The in-vehicle device 30 transmits, as vehicle diagnostic information, an abnormality of an in-vehicle system detected by a fault diagnostic device (not shown) of the subject vehicle, to the first server apparatus 10. The fault diagnostic function is referred to as a remote diagnostic function. The vehicle diagnostic information is also included in the vehicle information. Examples of the abnormality of the in-vehicle system include various lights going out, a fault of various sensors, or the like. When an abnormality occurs in the in-vehicle system, a warning light of the vehicle is turned on.

The frequency of acquiring the vehicle information can be appropriately determined by an experiment or the like, and may be, for example, once every few minutes. The frequency of transmitting the vehicle information can be appropriately determined by an experiment or the like, and may be, for example, equal to the frequency of acquiring the vehicle information. The transmitted vehicle information is attached with identification information for identifying a vehicle. The identification information is, for example, a vehicle identification number (VIN).

When the vehicle is maintained at a dealership or the like, the third terminal device 24 receives an input of maintenance information of the vehicle from an employee or the like, and transmits the received maintenance information to the first server apparatus 10. Examples of the maintenance information include information on the replacement of a part, such as a battery, a light, and an oil filter, which has been replaced by maintenance of the vehicle, and information of the date and the time of replacement thereof, information on the replacement of oil, such as engine oil and brake fluid which has been replaced by maintenance of the vehicle, and information of the date and the time of replacement thereof. The maintenance information is attached with the identification information of the vehicle.

When a used vehicle is sold to a new owner by a dealer, a used vehicle seller, or the like, the first terminal device 20, the second terminal device 22, or the third terminal device 24 receives an input of ownership change information of the vehicle from an employee or the like, and transmits the received ownership change information to the first server apparatus 10. Examples of the ownership change information include information on an attribute of the owner indicating, for example, whether the owner is an individual or a corporation, and information on the time of the ownership change. The ownership change information is attached with the identification information of the vehicle.

When purchasing a vehicle, a vehicle purchaser acquires, from an original owner of the vehicle, declaration information including information on, for example, whether the vehicle has accident history, flood damage history, and history of no response to a recall. The first terminal device 20 transmits the declaration information to the first server apparatus 10. The declaration information is attached with the identification information of the vehicle.

The vehicle information, maintenance information, ownership change information, and declaration information are collectively referred to as history information. The vehicle information and the maintenance information may be associated with each other based on date and time information.

The first server apparatus 10 of the data distributor regularly acquires history information of a plurality of vehicles from, for example, the in-vehicle devices 30 of the plurality of vehicles and accumulates the acquired history information for each vehicle. The first server apparatus 10 stores the history information for each vehicle in association with the identification information for each vehicle. The first server apparatus 10 collects the history information of each vehicle from the time at which it is sold as a new car until the time at which it is scrapped.

Based on the history information accumulated as above, the first server apparatus 10 provides the auction company with a vehicle status check sheet of the vehicle exhibited in the auction. The flow of data at the above time will be described below.

The first terminal device 20 of the exhibitor transmits the identification information of the vehicle exhibited in the auction to the second server apparatus 12 of the auction company. The second server apparatus 12 acquires the identification information of the exhibited vehicle, and transmits the acquired identification information to the first server apparatus 10. When there is a list of exhibited vehicles, the second server apparatus 12 may transmit in advance the identification information of all the vehicles on the list to the first server apparatus 10.

Based on the acquired identification information, the first server apparatus 10 acquires the history information of the exhibited vehicle from a database, and based on the acquired history information, prepares a vehicle status check sheet, which is provision information, on the exhibited vehicle. The first server apparatus 10 provides the prepared vehicle status check sheet to the second server apparatus 12.

The vehicle status check sheet includes, for example, the driving tendency of the past driver of the vehicle, an evaluation of the engine and the drive battery, a maintenance status, fault history, accident history, and vehicle ownership history. The driving tendency indicates the driving tendency of the driver of the exhibited vehicle, which is difficult to be realized by checking or inspecting the exterior of the exhibited vehicle. Details of the vehicle status check sheet will be described below.

The second server apparatus 12 provides the provided vehicle status check sheet of the exhibited vehicle to the exhibitor and/or the bidder in response to their request. On the screen of the first terminal device 20 for the exhibitor, information, such as an image, vehicle type, model year, and mileage of the exhibited vehicle and an icon for displaying the vehicle status check sheet are displayed. Similar information is also displayed on the screen of the second terminal device 22 for the bidder. When the icon for displaying the vehicle status check sheet is selected, the first terminal device 20 requests the vehicle status check sheet from the second server apparatus 12 and displays the vehicle status check sheet received from the second server apparatus 12 in response to the request on the screen for the exhibitor. The second terminal device 22 operates in a similar manner. The second server apparatus 12 may charge the exhibitor and/or the bidder who displayed the vehicle status check sheet a fee for the vehicle status check sheet displayed on the screen. Alternatively, the second server apparatus 12 may provide the vehicle status check sheet free of charge.

The bidder may be able to determine a more appropriate bid price by checking the vehicle status check sheet. Similarly, the exhibitor may be able to determine a more appropriate minimum successful bid price by checking the vehicle status check sheet. In other words, it may be possible for an auction participant to determine a bid price with improved accuracy for the exhibited vehicle. Since the bid price is determined in consideration of the interior of the vehicle in addition to the exterior thereof, even though a vehicle has not won a bid due to its exterior such as color at a conventional auction in which the vehicle status check sheet has not been provided, it is expected to be easier for the vehicle to win a bid with a good interior.

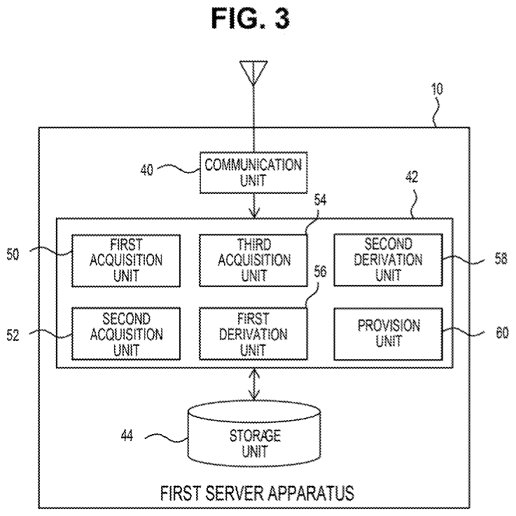

FIG. 3 is a block diagram illustrating a configuration of the first server apparatus 10 of FIG. 1. The first server apparatus 10 includes a communication unit 40, a processing unit 42, and a storage unit 44. The processing unit 42 includes a first acquisition unit 50, a second acquisition unit 52, a third acquisition unit 54, a first derivation unit 56, a second derivation unit 58, and a provision unit 60. Although the first server apparatus 10 is illustrated as one server in FIG. 3, the first server apparatus 10 may be composed of one server, or two or more servers that can communicate with each other.

The configuration of the processing unit 42 can be implemented by a CPU, memory, and other electronic circuits, such as an LSI, of a certain computer in terms of hardware, and implemented by a program or the like loaded in memory in terms of software. In the present application, a functional block implemented by a combination of hardware and software is illustrated. Accordingly, a person skilled in the art would understand that the functional blocks can be implemented in various forms by hardware alone, software alone, or a combination thereof.

The communication unit 40 communicates with the plurality of in-vehicle devices 30, the second server apparatus 12, and the like. The communication unit 40 may include a transmitter and a receiver. The communication unit 40 periodically receives the history information of the plurality of vehicles from the plurality of in-vehicle devices 30 and the like and outputs the received history information of the plurality of vehicles to the third acquisition unit 54.

The third acquisition unit 54 acquires the history information of the plurality of vehicles received by the communication unit 40, and stores, in the storage unit 44, the acquired history information of the plurality of vehicles in association with the identification information thereof.

The first derivation unit 56 periodically derives statistical information of the history information of the plurality of vehicles for each vehicle type, and stores the derived statistical information in the storage unit 44. The statistical information includes, for example, an average of evaluation values of each characteristic, such as engine torque and output, an average of evaluation values of the driving tendency, an average of fuel consumption, and a maximum value of fuel consumption.

The first derivation unit 56 may derive the statistical information of each vehicle type for each model year and furthermore may derive the statistical information of each model year for each mileage segment.

The communication unit 40 receives the identification information of the vehicle exhibited in the auction from the second server apparatus 12, and outputs the received identification information to the first acquisition unit 50. The first acquisition unit 50 acquires the identification information of the exhibited vehicle, received by the communication unit 40.

Based on the identification information acquired by the first acquisition unit 50, the second acquisition unit 52 acquires, from the storage unit 44, the history information of the exhibited vehicle, and the statistical information of the vehicle type of the exhibited vehicle.

The second derivation unit 58 derives the vehicle status check sheet of the exhibited vehicle based on the identification information acquired by the first acquisition unit 50, and the history information and the statistical information acquired by the second acquisition unit 52.

Based on the acquired identification information, the second derivation unit 58 specifies a vehicle type, model, model year, vehicle equipment, and items of the acquired vehicle information. Then, the second derivation unit 58 derives basic information of the exhibited vehicle based on the specified vehicle type, model, model year, vehicle equipment, items of the acquired vehicle information, and the history information. The basic information is a candidate for the information included in the vehicle status check sheet. The basic information includes vehicle type, model, model year, vehicle equipment, mileage, accident history, flood damage history, no response to a recall, evaluation of the engine, evaluation of the drive battery, fuel consumption, travel frequency, mileage for one travel, the driving tendency of the past driver of the vehicle, warning light-on history, and maintenance history. The vehicle equipment includes optional equipment, and may include a navigation system, a rear view monitor, and safety equipment. Examples of the safety equipment include an anti-lock brake system (ABS), lane keeping assist (LKA), and automatic braking.

The second derivation unit 58 may derive, in a predetermined format, the vehicle status check sheet including all the derived basic information regardless of the auction company, the destination to which the provision information is provided by the auction company, or the type of the exhibited vehicle. In this case, since the vehicle status check sheet is provided in a predetermined format, the vehicle status can be presented to the exhibitor or the bidder in a fair manner, that is, in a transparent manner.

The second derivation unit 58 may extract, from the derived basic information, information determined according to at least one of the auction company, the destination to which the provision information is provided by the auction company, the type of the exhibited vehicle, and the model of the exhibited vehicle. Then, the second derivation unit 58 may derive a vehicle status check sheet including the extracted information in a predetermined format according to at least one of the auction company, the destination to which the provision information is provided by the auction company, the type of the exhibited vehicle, and the model of the exhibited vehicle. For example, whether the vehicle status check sheet includes the evaluation information of the engine may differ depending on a contract with the auction company. As such, it is possible to provide a vehicle status check sheet having an amount of information that matches the destination to which the vehicle status check sheet is provided, and the type and model of the exhibited vehicle.

Moreover, for example, in a case of a vehicle for which it has been 15 years since it was sold as a new car, the period for the vehicle information used for deriving the vehicle status check sheet may differ depending on whether the vehicle status check sheet is based on, for example, the vehicle status check sheet based on the vehicle information for the latest five years or for the entire 15 years. For the maintenance information, ownership change information, and declaration information, information for an entire period may be preferably used. When a vehicle status check sheet is derived based on the vehicle information for a latest predetermined period, the processing unit 42 may delete, from the storage unit 44, the vehicle information of which the period is older than the predetermined period. As such, the amount of data stored in the storage unit 44 can be reduced.

The period of the vehicle information to be used may differ depending on the information to be derived. For example, the driving tendency may be derived based on the vehicle information for the entire period, and the fuel consumption may be derived based on the vehicle information for the latest predetermined period.

The provision unit 60 provides the vehicle status check sheet derived by the second derivation unit 58 to the second server apparatus 12 of the auction company via the communication unit 40. The process thereafter by the second server apparatus 12 is as described above.

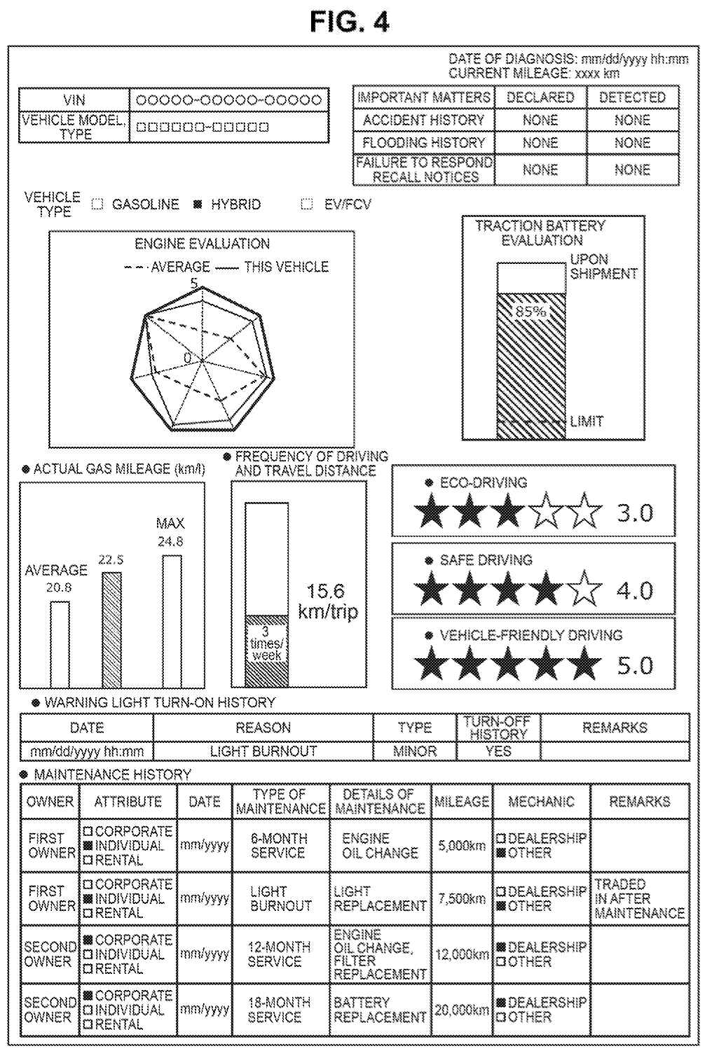

FIG. 4 illustrates an exemplified display of a vehicle status check sheet of a hybrid-type vehicle, prepared by the first server apparatus 10 of FIG. 1. The vehicle status check sheet includes the vehicle type, mileage, accident history, flooding history, no response to a recall, evaluation of the engine, the evaluation of the drive battery, fuel efficiency, travel frequency, a one-time traveling distance (mileage), the driving tendency of the past driver of the vehicle, the warning light-on history, and the maintenance history.

The accident history, flood damage history, and no response to a recall respectively includes whether there has been a declaration thereof by a past owner of the vehicle, and whether there has been detection thereof in the vehicle information or the maintenance information. The second derivation unit 58 derives whether there has been a declaration based on the declaration information. Further, the second derivation unit 58 derives whether there has been detection of the accident history based on, for example, a change in the acceleration in the vehicle information. Moreover, the second derivation unit 58 derives whether there has been detection of the flood damage history and no response to a recall based on the maintenance information.

The evaluation of the engine includes, for example, an evaluation value of a target vehicle and an average of evaluation values of a plurality of vehicles, with respect to each item, such as torque, output, RPM, response, quietness, and fuel consumption. The second derivation unit 58 derives the evaluation value of the target vehicle based on, for example, various sensor values of the engine in the vehicle information. The average evaluation value indicates an average of evaluation values of a plurality of vehicles that are divided by items of the same vehicle type, model year, and mileage as the exhibited vehicle. The evaluation result of the engine can also be regarded as a measure of engine health.

The exhibitor or the bidder can realize a relative engine state of the exhibited vehicle, by comparing it with an average engine state of the plurality of vehicles that are divided into items including the same vehicle type, model year, and mileage as the exhibited vehicle. In addition, the evaluation of the engine may include an evaluation value of a new vehicle of the same vehicle type or model as the exhibited vehicle, and compare an evaluation value of the exhibited vehicle with the evaluation value of the new vehicle. Further, since an average of the evaluation values is the average of the evaluation values of a plurality of unspecified vehicles, the evaluation value of the exhibited vehicle can be compared with highly accurate averages, including vehicles that have not been distributed in a used vehicle market.

When a vehicle type is a sports car, the number of items for evaluation of the engine may be larger than when the vehicle type is a compact car or the like, because, in this case, the exhibitor or the bidder may desire to know a more detailed evaluation of the engine. In a vehicle type having a relatively low performance engine, an evaluation of the engine is represented by one evaluation value and does not need to have various evaluation items, because, in this case, the exhibitor or the bidder may desire to know a simple evaluation of the engine. As such, it is easier for the exhibitor or the bidder to be provided with desirable information.

In evaluation of the drive battery, the deterioration state is represented by numerical values. The lower the numerical value is, the more the deterioration of the drive battery is progressing. The second derivation unit 58 derives the evaluation of the drive battery based on, for example, various sensor values associated with the drive battery in the vehicle information. The evaluation result of the drive battery can also be regarded as a measure of the health of the drive battery.

The fuel consumption includes fuel consumption of the target vehicle, an average fuel consumption, and a maximum fuel consumption. The average fuel consumption indicates average fuel consumption of a plurality of vehicles of the same vehicle type and model year as the target vehicle. The maximum fuel consumption indicates the maximum value of fuel consumption of the plurality of vehicles of the same vehicle type and model year as the target vehicle. The second derivation unit 58 derives the fuel consumption based on, for example, fuel consumption per unit time and the odometer value in the vehicle information.

The travel frequency indicates an average number of travels per predetermined period, for example, one week. Mileage for one travel indicates an average mileage for one travel. The second derivation unit 58 derives the travel frequency and the mileage for one travel based on, for example, the odometer value, the date and time information attached to the odometer value in the vehicle information.

The driving tendency includes, for example, an evaluation value of each item, such as “eco-driving”, “safe driving”, and “driving with low load on the vehicle”. The evaluation value of “eco-driving” is lower as the fuel consumption is worse, and as the period in which eco-mode is selected is shorter. An evaluation value of “safe driving” is lower as the number of operations of safety equipment, such as the ABS, is larger. An evaluation value of “driving with low load on the vehicle” is lower as the number of harsh acceleration, harsh steering, and harsh braking is higher. The second derivation unit 58 derives the driving tendency based on the vehicle information. Since the exhibitor or the bidder can realize how the exhibited vehicle was driven by the past driver based on the driving tendency, it is likely to be an effective element in determining the bid price.

Each item of the driving tendency may also include an average of the evaluation values of vehicles of the same vehicle type as the exhibited vehicle, based on history information of a plurality of vehicles. For example, in a case of a sports car, when it is compared to a different type of vehicle, its evaluation value of “eco-driving” may decrease. However, when it is compared to an average of the evaluation values of vehicles of the same vehicle type, the driving tendency is likely to be an effective element in determining the bid price.

The warning light-on history includes a date when the light is on, a reason for the light on, a classification, and warning light-off history, and can also be referred to as fault history. The second derivation unit 58 derives the warning light-on history based on the vehicle diagnostic information. With the warning light-on history, the exhibitor or the bidder can realize the status of the past fault of the exhibited vehicle.

The maintenance history includes information indicating what number owner of the vehicle is the present owner at the time of maintenance, an attribute of an owner, a date of maintenance, the type of maintenance, the content of maintenance, a mileage at the time of maintenance, and information on a mechanic. The second derivation unit 58 derives the maintenance history based on the maintenance information. With the maintenance history, the exhibitor or the bidder can realize whether the exhibited vehicle has been appropriately maintained.

Although illustration is omitted, the vehicle status check sheet may include information on whether there is optional vehicle equipment.

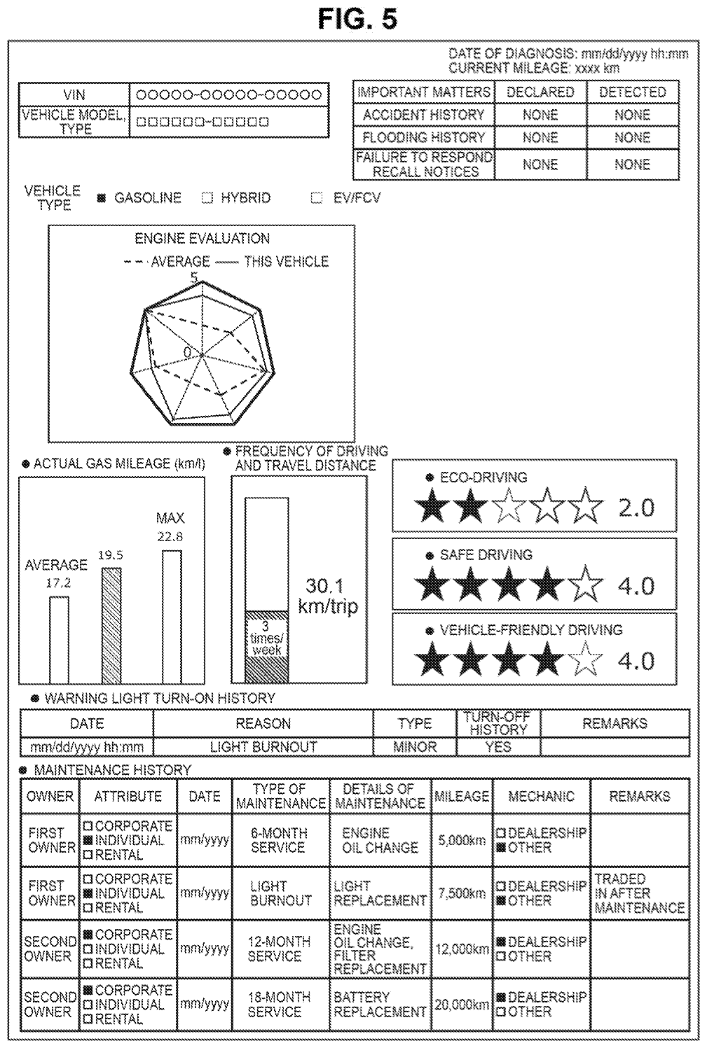

FIG. 5 illustrates an exemplified display of a vehicle status check sheet of a gasoline-powered vehicle, prepared by the first server apparatus 10 of FIG. 1. The vehicle status check sheet of FIG. 5 differs from the vehicle status check sheet of FIG. 4 in that the former does not include the evaluation of the drive battery. The vehicle status check sheet may include an evaluation of a lead battery used for engine ignition and the like.

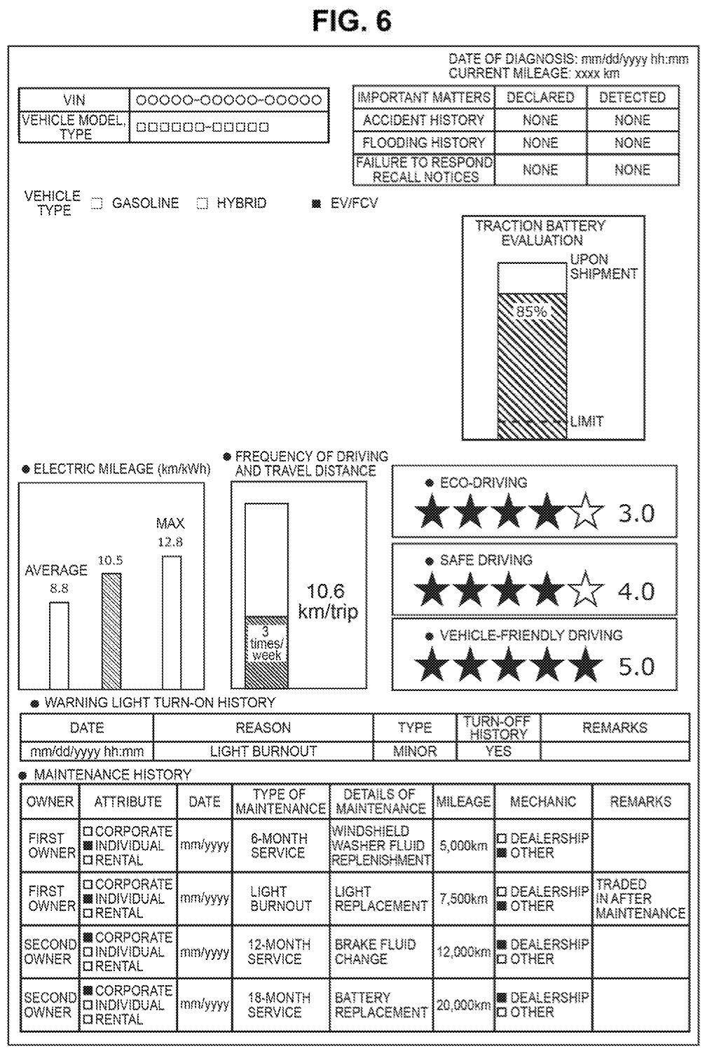

FIG. 6 illustrates an exemplified display of a vehicle status check sheet of an electric vehicle (EV) or a fuel cell vehicle (FCV), prepared by the first server apparatus 10 of FIG. 1. The vehicle status check sheet of FIG. 6 differs from the vehicle status check sheet of FIG. 4 in that the former does not include the evaluation of the engine, and includes an electricity efficiency instead of fuel efficiency. The electricity efficiency represents a traveling distance per unit electric power consumption.

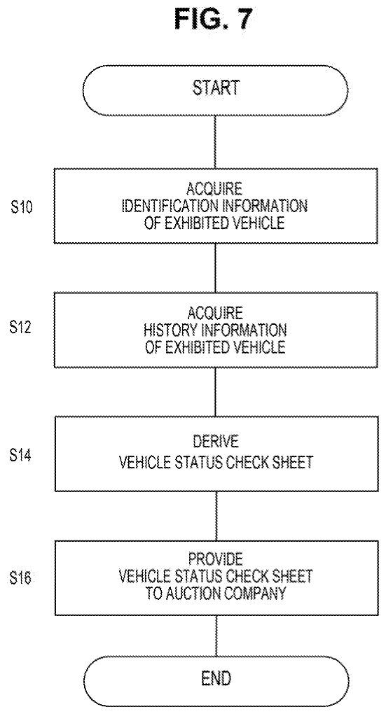

Next, the overall operation of the first server apparatus 10 having the above configuration will be described. FIG. 7 is a flowchart illustrating a process of the first server apparatus 10 of FIG. 1. A process of FIG. 7 is performed each time the identification information of the exhibited vehicle is provided from the second server apparatus 12 of the auction company. The first server apparatus 10 acquires the identification information of the exhibited vehicle from the auction company (S10), and based on the acquired identification information, acquires the history information of the exhibited vehicle (S12). Based on the acquired history information, the first server apparatus 10 derives the vehicle status check sheet (S14), and provides the derived vehicle status check sheet to the auction company (S16).

With the present embodiment, since the provision information including the driving tendency of the past driver of the exhibited vehicle can be provided to the auction participant, it is expected that the participant can determine a bid price with improved accuracy for the exhibited vehicle.

### Second Embodiment

A second embodiment differs from the first embodiment in that the maintenance information is also used, along with other information, in preparing the evaluation of the engine and the battery, and the like, for the vehicle status check sheet. Hereinafter, the second embodiment will be described, mainly focused on its differences from the first embodiment.

With respect to a part or oil for which a replacement time recommended by the car manufacturer is determined, the second derivation unit 58 derives the vehicle status check sheet based on information on a part or oil replacement date and time in the maintenance information of the exhibited vehicle, and a predetermined replacement time. The replacement time is set for each part or oil, and may be set for each vehicle type. Examples of parts or oils for which the replacement time are determined include engine oil, an oil filter, brake oil, a spark plug, and a lead battery.

The replacement of engine oil will be described as an example. The engine oil is replaced relatively frequently, for example, once a year or every 15,000 km traveled. In the second embodiment, the evaluation of the engine is represented by one evaluation value. If the engine oil has been replaced by the replacement time, the second derivation unit 58 does not deduct values from the evaluation of the engine. If the engine oil has not been replaced by the replacement time, the second derivation unit 58 deducts values from the evaluation of the engine. The larger the number of times the engine oil has not been replaced by the replacement time is, the more the second derivation unit 58 may deduct values from the evaluation of the engine. As such, it is possible to provide a vehicle status check sheet reflecting whether the part or oil for which the recommended replacement time is determined has been replaced at an appropriate time.

In addition, the second derivation unit 58 derives the vehicle status check sheet for a predetermined part based on the vehicle information on the replaced part of the target vehicle after the replacement date and time. An example of the predetermined part may be a drive battery.

If the drive battery has been replaced, the second derivation unit 58 derives the evaluation of the drive battery based on the vehicle information after the replacement date and time of the drive battery. This is because if the drive battery has been replaced, the vehicle information on the drive battery before replacement is irrelevant to the evaluation of the drive battery after replacement. As such, it is possible to provide an accurate evaluation of the replaced part.

With the present embodiment, it is possible to provide a highly accurate vehicle status check sheet that reflects the maintenance status of a vehicle.

As above, the present disclosure was described based on the embodiments. A person skilled in the art would understand that the embodiments are merely illustrative and other variations may be made according to combinations of each component and each process within the technical scope of the present disclosure.

In present embodiments, an example in which the second derivation unit 58 derives the vehicle status check sheet based on the history information of the exhibited vehicle after acquiring the identification information of the exhibited vehicle has been described. However, the second derivation unit 58 may periodically derive in advance the vehicle status check sheet based on the history information for each of the plurality of vehicles. The second derivation unit 58 stores, in the storage unit 44, the derived vehicle status check sheet of each vehicle in association with the identification information of the each vehicle. The second acquisition unit 52 acquires, from the storage unit 44, the vehicle status check sheet of the exhibited vehicle based on the identification information of the exhibited vehicle, acquired by the first acquisition unit 50. The provision unit 60 provides the auction company with the vehicle status check sheet acquired by the second acquisition unit 52. In the present modification, the degree of freedom in the configuration of the first server apparatus 10 can be improved.

In the present modification, the provision unit 60 may provide the derived vehicle status check sheet to, for example, the in-vehicle device 30 of the vehicle or a mobile terminal of the owner of the vehicle each time the vehicle status check sheet is derived. In the present modification, the owner of the vehicle can realize the current state of the vehicle.

Further, after checking the vehicle status check sheet, the exhibitor may determine that it is desirable to add additional information to the vehicle status check sheet to increase the successful bid price even though an additional charge is paid. In this case, in response to the exhibitor's operation, the first terminal device 20 of the exhibitor may request the second server apparatus 12 of the auction company to acquire the additional information that is not included in the vehicle status check sheet. The second server apparatus 12 transmits the request for the additional information to the first server apparatus 10. In response to the request for the additional information, the first server apparatus 10 derives a new vehicle status check sheet to which information that is not included in the current vehicle status check sheet among the basic information is added as the additional information, and transmits the new vehicle status check sheet to the second server apparatus 12. Subsequently, the second server apparatus 12 charges the exhibitor a fee, and transmits the new vehicle status check sheet to the first terminal device 20 and the second terminal device 22. In the present modification, in response to the exhibitor's request, it is possible to provide the additional information that can increase the successful bid price.

The second derivation unit 58 may derive the vehicle status check sheet without using the statistical information. In the present modification, it is possible to simplify the process of the first server apparatus 10 and reduce the amount of the stored data. Moreover, the first derivation unit 56 may derive the statistical information of the history information of the plurality of vehicles for each format.

What is claimed is:

1. A server apparatus comprising circuitry configured to:
acquire identification information of an exhibited vehicle which is exhibited in an auction from an auction company;
acquire history information of the exhibited vehicle based on the identification information;
derive provision information including a driving tendency of a past driver of the exhibited vehicle based on the history information; and
provide the provision information to the auction company.

2. The server apparatus according to claim 1, wherein
the circuitry is configured to derive the provision information in a predetermined format according to at least one of the auction company, a destination to which the auction company provides the provision information, a type of the exhibited vehicle, and a model of the exhibited vehicle.

3. The server apparatus according to claim 1, wherein
the circuitry is configured to derive the provision information in a predetermined format.

4. The server apparatus according to claim 1, wherein
the history information includes maintenance information of the exhibited vehicle.

5. The server apparatus according to claim 1, further comprising:
a memory configured to store history information of a plurality of vehicles, wherein
the circuitry is configured to:
prepare statistical information of the history information of the plurality of vehicles based on the history information of the plurality of vehicles; and
derive the provision information based on the statistical information.

6. The server apparatus according to claim 1, wherein
the driving tendency is calculated based on at least one of an evaluated value for eco-driving, an evaluated value for safe driving, and an evaluated value for vehicle-friendly driving, the evaluated value for the eco-driving being calculated based on at least one of a gas mileage of the exhibited vehicle and a length of an overall period during which an eco-mode is selected, the evaluated value for the safe driving being calculated based on the number of times a safety equipment mounted on the exhibited vehicle is activated, the evaluation value for the vehicle-friendly driving being calculated based on information relating to rapidity of acceleration, deceleration and steering of the exhibited vehicle.

7. The server apparatus according to claim 1, wherein
the circuitry is configured to provide, in response to a request from the auction company, additional information including information that is not included in the provision information to the auction company, after providing the provision information to the auction company.

8. An information provision method comprising:
(a) acquiring identification information of an exhibited vehicle that is exhibited in an auction from an auction company;
(b) acquiring history information of the exhibited vehicle based on the identification information;
(c) deriving provision information including a driving tendency of a past driver of the exhibited vehicle based on the history information; and
(d) providing the provision information to the auction company.

9. The information provision method according to claim 8, wherein
the step of (c) includes deriving the provision information in a predetermined format according to at least one of the auction company, a destination to which the auction company provides the provision information, a type of the exhibited vehicle, and a model of the exhibited vehicle.

10. The information provision method according to claim 8, wherein
the step of (c) includes deriving the provision information in a predetermined format.

11. The information provision method according to claim 8, wherein
the history information includes maintenance information of the exhibited vehicle.

12. The information provision method according to claim 8, further comprising:
(e) storing history information of a plurality of vehicles in a memory, wherein the step of (c) includes:
preparing statistical information of the history information of the plurality of vehicles based on the history information of the plurality of vehicles; and
deriving the provision information based on the statistical information.

13. The information provision method according to claim 8, wherein
the driving tendency is calculated based on at least one of an evaluated value for eco-driving, an evaluated value for safe driving, and an evaluated value for vehicle-friendly driving, the evaluated value for the eco-driving being calculated based on at least one of a gas mileage of the exhibited vehicle and a length of an overall period during which an eco-mode is selected, the evaluated value for the safe driving being calculated based on the number of times a safety equipment mounted on the exhibited vehicle is activated, the evaluation value for the vehicle-friendly driving being calculated based on information relating to rapidity of acceleration, deceleration and steering of the exhibited vehicle.

14. The information provision method according to claim 8, further comprising
(f) providing, in response to a request from the auction company, additional information including information that is not included in the provision information to the auction company, after the step of (d).

15. An information provision method comprising:
(a) acquiring history information of a plurality of vehicles;
(b) deriving provision information including a driving tendency of a past driver of each of the plurality of vehicles based on the history information, and storing the provision information in a memory;
(c) acquiring identification information of an exhibited vehicle exhibited in an auction from an auction company, the exhibited vehicle being included in the plurality of vehicles;
(d) acquiring the provision information of the exhibited vehicle from the memory, based on the identification information; and
(e) providing the provision information of the exhibited vehicle to the auction company.

16. The information provision method according to claim 15, wherein
the step of (b) includes deriving the provision information in a predetermined format according to at least one of the auction company, a destination to which the auction company provides the provision information, and a type of the exhibited vehicle, and a model of the exhibited vehicle.

17. The information provision method according to claim 15, wherein
the step of (b) includes deriving the provision information in a predetermined format.

18. The information provision method according to claim 15, wherein
the history information includes maintenance information of the exhibited vehicle.

19. The information provision method according to claim 15, wherein
the step of (b) includes:
preparing statistical information of the history information of the plurality of vehicles based on the history information of the plurality of vehicles; and
deriving the provision information based on the statistical information.

20. The information provision method according to claim 15, wherein
the driving tendency is calculated based on at least one of an evaluated value for eco-driving, an evaluated value for safe driving, and an evaluated value for vehicle-friendly driving, the evaluated value for the eco-driving being calculated based on at least one of a gas mileage of the exhibited vehicle and a length of an overall period during which an eco-mode is selected, the evaluated value for the safe driving being calculated based on the number of times a safety equipment mounted on the exhibited vehicle is activated, the evaluation value for the vehicle-friendly driving being calculated based on information relating to rapidity of acceleration, deceleration and steering of the exhibited vehicle.
